(19) United States
(12) Patent Application Publication
(10) Pub. No.: US 2026/0095935 A1
(43) Pub. Date: Apr. 2, 2026

(54) Power Save Operation and AP Behavior for Coex Unavailability

(71) Applicant: Apple Inc., Cupertino, CA (US)

(72) Inventors: Qi Wang, Mountain View, CA (US); Yanjun Sun, San Diego, CA (US); Abdel Karim Ajami, San Jose, CA (US); Jarkko L. Kneckt, Los Gatos, CA (US); Oren Shani, Saratoga, CA (US); Neelakantan Nurani Krishnan, San Diego, CA (US); Yong Ho Seok, Cupertino, CA (US); Anuj Batra, Redwood City, CA (US); Ahmad Reza Hedayat, Carlsbad, CA (US); Helena D. O'Shea, San Diego, CA (US); Yoel Boger, Shoham (IL); Yong Liu, Campbell, CA (US)

(21) Appl. No.: 19/315,213

(22) Filed: Aug. 29, 2025

Related U.S. Application Data
(60) Provisional application No. 63/700,466, filed on Sep. 27, 2024.
(60) Provisional application No. 63/709,742, filed on Oct. 21, 2024.

(51) Int. Cl. H04W 74/08; H04W 74/00

(52) U.S. Cl. CPC H04W 74/08; H04W 74/004

(57) ABSTRACT

Methods and apparatus are contemplated for transmission of data in a wireless local area network. In embodiments, a first wireless device (AP) is configured to transmit data packets to a second wireless device (STA), and transmits an initial control frame (ICF) to the STA indicating a transmission opportunity time period (TXOP) for data transfer from the first wireless device to the second wireless device. In response to the ICF, the second wireless device returns an initial control response (ICR) indicating an unavailability time period, e.g., Coex unavailability. Alternatively, the STA may send to the AP without prompt, an unsolicited unavailability announcement (UUA) containing unavailability information of the STA. Responsive to receipt of the ICR or UUA, the AP may modify a transmission plan, e.g., shorten or cancel the TXOP, or transmit a portion of the data to another STA, etc. Power settings may be determined based on the unavailability time period.

### PRIORITY INFORMATION

This application claims priority to U.S. Provisional Patent Application No. 63/709,742, entitled “Power Save Operation and AP behavior for Coex Unavailability,” filed Oct. 21, 2024, and U.S. Provisional Patent Application No. 63/700,466, entitled “Power Save Operation and AP behavior for Coex Unavailability,” filed Sep. 27, 2024, which are hereby incorporated by reference in their entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### TECHNICAL FIELD

The present application relates to wireless communication, including techniques and devices for implementing and processing coexistence (Coex) unavailability in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to transmit and receive unavailability announcements for co-existence in a wireless local area network architecture, and to determine data transmission, e.g., transmission opportunity (TXOP) and adjust transmission duration based on unavailability of a device.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flow chart of an ICF/ICR exchange, according to embodiments described herein;

FIGS. 6A, 6B illustrate a timeline for data packet transfer between an AP and a STA that has an unavailability period, according to embodiments.

FIG. 7 illustrates, according to embodiments, a timeline for data packet transfer between an AP and a STA that has a Coex unavailability period that partially overlaps with a planned AP transmission opportunity (TXOP).

FIG. 8 illustrates, according to embodiments, a timeline for data packet transfer between an AP and a STA that has a Coex unavailability period that occurs within a time duration of a planned AP TXOP.

FIG. 9 illustrates, according to embodiments, a timeline for exchange of ICF and ICR, where the ICR includes an announcement of a STA Coex unavailability period, and for update of a previously announced Coex unavailability period before start of the previously announced Coex unavailability period.

FIG. 10 illustrates, according to embodiments, a timeline for exchange of ICF and ICR and subsequent data transmission, where the ICR includes an announcement of a STA Coex unavailability period and for update of a previously announced Coex unavailability period during the previously announced Coex unavailability period.

FIG. 11 illustrates, according to embodiments, a timeline for attempted exchange of ICF and ICR, ICF/ICR failures and subsequent repeat of the ICF/ICR exchange where there is a block acknowledgement (BA) agreement established, where STA has a Coex unavailability duration during the attempted ICF/ICR exchange.

FIGS. 12A,B illustrate, according to embodiments, mitigation of negative impacts of an ICF/ICR failure where there is a block acknowledgement (BA) agreement, where STA has a Coex unavailability duration during an attempted and failed ICF/ICR exchange.

FIG. 13 illustrates, according to embodiments, a timeline for attempted exchange of ICF and ICR, ICF/ICR failures, and subsequent repeat of the ICF/ICR exchange where there is no block acknowledgement (BA) agreement established, where STA has a Coex unavailability duration during the attempted and failed ICF/ICR exchange.

FIGS. 14A,B illustrate, according to embodiments, mitigation of negative impacts of ICF/IR failure where there is no block acknowledgement (BA) agreement established, where STA has a Coex unavailability duration during the attempted and failed ICF/ICR exchange.

FIG. 15 illustrates, according to embodiments, AP rate adaptation due to ICF/ICR failures, with or without BA agreement.

FIGS. 16A,B illustrate, according to embodiments, data packet failure and recovery methods for cases in which unavailability duration is partially within a planned TXOP and partially outside of the planned TXOP.

FIG. 17A,B illustrate, according to embodiments, data packet failure and recovery methods for cases in which unavailability duration lies entirely within a planned TXOP.

FIG. 18 illustrates, according to embodiments, acknowledgment of AP's receipt of STA Coex unavailability when the AP continues the TXOP with STA1.

FIG. 19A illustrates, according to embodiments, acknowledgment of AP's receipt of STA Coex unavailability when the AP terminates TXOP, where STA1 has an unavailability period.

FIG. 19B illustrates, according to embodiments, acknowledgment of AP's receipt of STA Coex unavailability when the AP terminates the transmission to STA1 and uses the TXOP for transmission of data to a STA 2, where STA1 has an unavailability period, and STA 2 is a third-party device.

FIG. 20A illustrates, according to embodiments, responsive to receipt of an ICF, an ICR that indicates Coex unavailability of the STA and power management mode of STA at the end of the Coex unavailability period.

FIG. 20B illustrates, according to embodiments, a UUA that indicates Coex unavailability of the STA and power management mode of STA at the end of the Coex unavailability period.

FIG. 20C describes, for embodiments illustrated in FIGS. 20A,B interactions with power management modes.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

The following is a list of acronyms used in this disclosure:
UE—User Equipment
AP—Access Point
UHR—ultra-high reliability
HE—High Efficiency
HT—High Throughput
EHT—Extremely High Throughput
MU—multi—user
MU-RTS—Multi-user Request to Send
MU-CTS—Multi-user Clear to Send
MU-BAR—Multi-user Block Acknowledgment Request
BSRP—Buffer Status Report Poll
TXOP—Transmission Opportunity
SIFS—Short Interframe Space
L-SIG—Legacy Signal
EIFS—extended inter-frame space
ICF—Initial Control Frame
ICR—Initial Control Response
EMLSR—enhanced multi-link single radio
BA—block acknowledgment
NAV—network allocation vector
PPDU—Physical Layer Protocol Data Unit
TB—Trigger-Based
QoS—Quality of Service
QN—QoS-Null

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

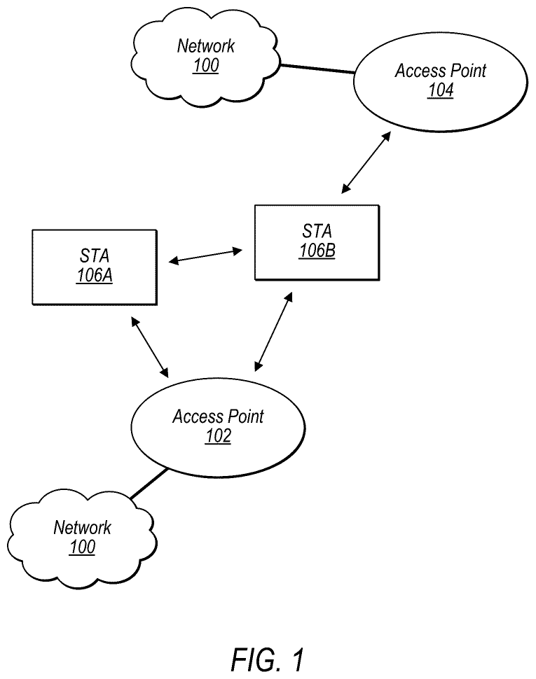

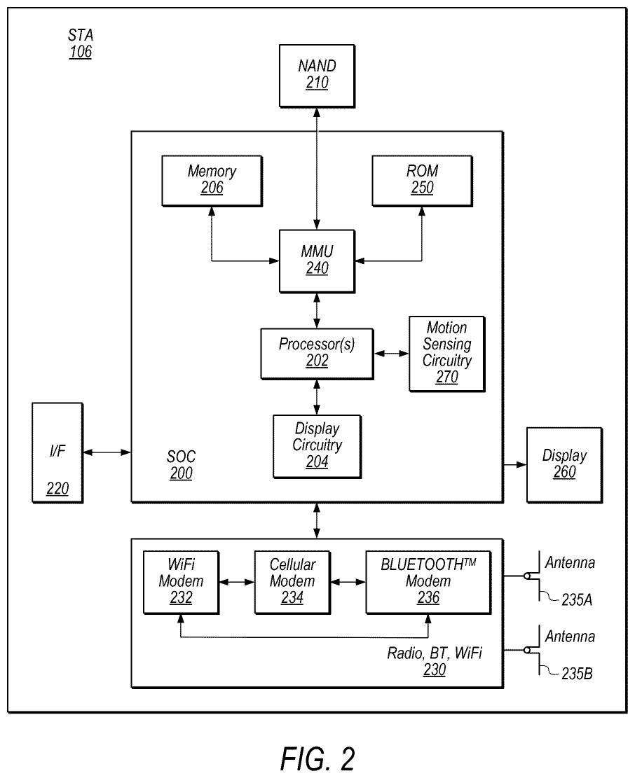

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for performing channel state information reporting for multi-transmission-reception-point operation in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for providing multi-user request-to-send and clear-to-send transmissions described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

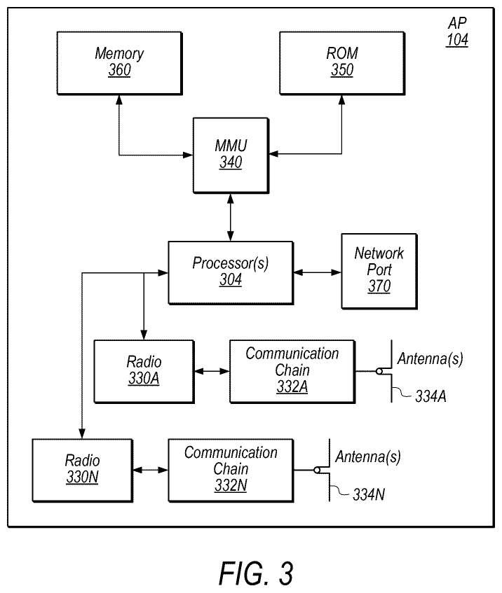

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as performing multi-user request-to-send and clear-to-send transmissions, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

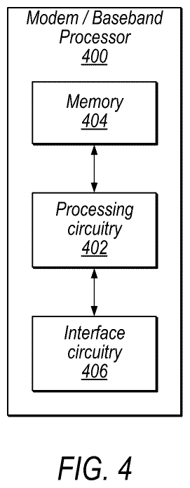

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as unavailability transmissions, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

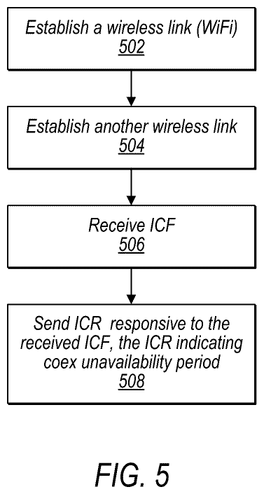

### FIG. 5—Transmission of Unavailability Information Flowchart

FIG. 5 is a flowchart diagram illustrating a method for supporting transmission of unavailability information in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements. As illustrated, the method may proceed as follows:

At 502, a wireless device establishes a first wireless connection using a first set of radio resources. The first wireless connection may utilize any of a variety of radio access technologies (RATs), such as WLAN, Bluetooth or a cellular RAT such as 5G NR. The first wireless connection may be made with a wireless access point (AP), in some embodiments.

At 504, the wireless device establishes a second wireless connection using the first set of radio resources. The second wireless connection may utilize any of a variety of radio access technologies (RATs), such as WLAN, Bluetooth or a cellular RAT such as 5G NR. Notably, the first and second wireless connection may share at least some radio resources (i.e., the “first set” of radio resources), such that coexistence events may potentially arise between the first and second wireless connections.

The first and second wireless connections may include associations established using Wi-Fi, wireless communication techniques that are based at least part on Wi-Fi, and/or any of various other wireless communication technologies, according to various embodiments. In some embodiments, the first and/or second wireless connections may include an infrastructure Wi-Fi connection. For example, a wireless AP may provide beacon transmissions including information for associating with the wireless AP, and one or more other wireless devices (e.g., non-AP wireless devices, which could include the wireless device) may request to associate with the wireless AP using the information provided in the beacon transmissions, as one possibility. In some embodiments, the first and/or second wireless connections may include a peer-to-peer (P2P) Wi-Fi connection, or a non-Wi-Fi connection such as a Bluetooth connection. For example, the wireless device may form a Wi-Fi connection with an AP as the first wireless connection, and a P2P Wi-Fi connection with another non-AP wireless device as the second wireless connection, as one possibility. As another example, the first wireless connection may be a WLAN connection, and the wireless device may form a Bluetooth wireless connection with a paired Bluetooth device as the second wireless connection, or with another wireless device according to another wireless communication technology, as further possibilities.

Variations and/or other techniques for establishing an association are also possible. In some embodiments, it may be possible that the multiple wireless connections established by the wireless device using the first set of radio resources could include more than two wireless connections. Note also that the radio resources shared by the multiple wireless connections may include part or all of the spectrum portions used by each of the wireless connections, according to various embodiments; in other words, the radio resources of the multiple wireless connections may be partially overlapping, or may be fully overlapping, in various instances. In some instances, the wireless device may additionally have one or more wireless connections that use radio resources that do not overlap with the first set of radio resources.

At 506, the wireless device receives an initial control frame (ICF) from a wireless access point over the first wireless connection.

At 508, based at least in part on receiving the ICF, the wireless device transmits a control response message (ICR) to the wireless access point. In embodiments, the control response message indicates unavailability information for the wireless device. The control response message may be sent a short interframe space (SIFS) after receiving the ICF, in some embodiments.

In some embodiments, the ICF is a BSRP frame, and the ICR control response message is a M-STA BA frame. The ICR messages include a duration field to indicate a future availability duration (NAV), an adjusted transmission opportunity (TXOP) duration, and the start time and duration of Coex unavailability.

In some embodiments, the indication of the time period of future unavailability includes a future unavailability start time, a minimum future unavailability duration, and/or a bitmap indicating one or more links involved in the future unavailability event. In some embodiments, a duration field in the control response message may be used to indicate the availability duration. The future unavailability start time value may be indicated as a portion of the TSF value.

In some embodiments, the unavailability information is for a single coexistence event over a single link, or it may be for multiple coexistence events involving multiple links. In some embodiments, rather than sending the ICR control message indicating the unavailability information in response to receiving the multi-user ICF, the wireless device may send, an unsolicited unavailability announcement (UUA) to communicate the unavailability information. The UUA may be sent after establishing the first and second wireless connections and determining that a future unavailability event will occur, but may be sent without receiving the ICF at step 506 (e.g., it is unsolicited). In these embodiments, the UUA may be included in a management frame, where it may be processed at a higher layer than a control frame (e.g., higher than a MAC layer). This may be particularly useful for cross-link unavailability information, where unavailability information related to an unavailability event over a first link is transmitted over a different second link. Thus, according to the method of FIG. 5, it may be possible to support use of unavailability information to manage the co-existence of multiple technologies (e.g., Wi-Fi and Bluetooth) and to manage Wi-Fi infrastructure and Wi-Fi peer-to-peer communication, for example to provide better handling of time shares between infrastructure and P2P or co-existence connections, among various possibilities. Such techniques may help reduce or avoid collisions, coexistence interference, unnecessary rate reduction from link adaptation, and/or provide any of a variety of other possible benefits, at least according to some embodiments.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired.

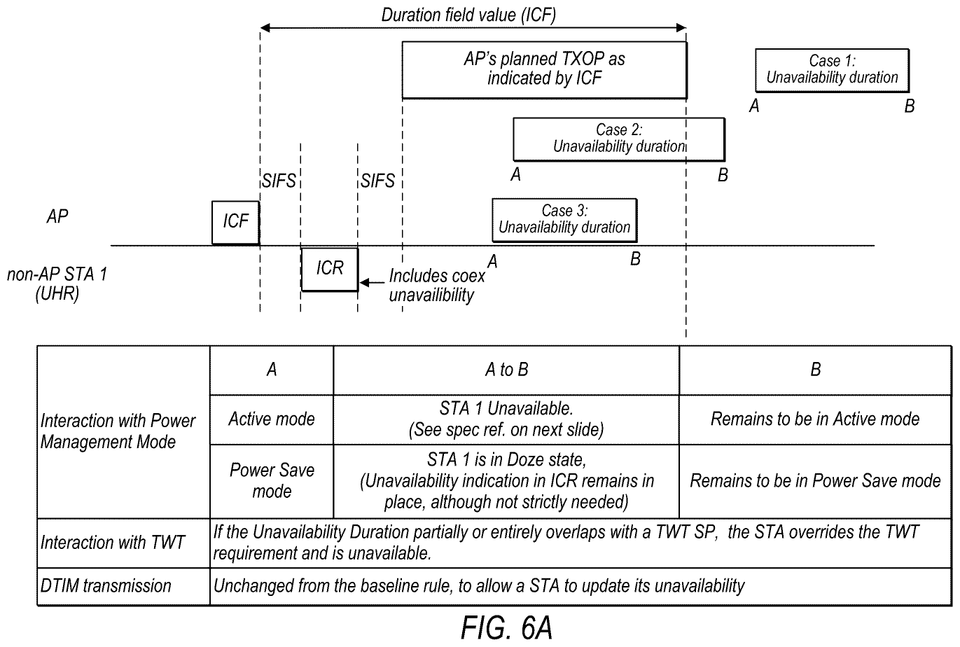

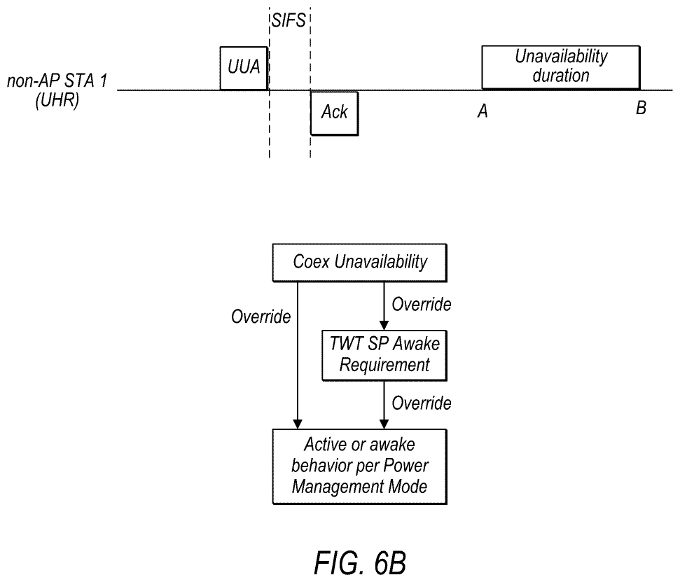

### FIGS. 6-20 and Additional Information

FIGS. 6-20 illustrate further aspects that might be used in conjunction with the method of FIG. 5. It should be noted, however, that the exemplary details illustrated in, and described with respect to, FIGS. 6-20 are not intended to be limiting to the disclosure as a whole: numerous variations and alternatives to the details provided herein below are possible and should be considered within the scope of the disclosure.

FIG. 6A illustrates a timeline illustrating temporal relationships between an AP and a STA that is to receive data packets from the AP, according to various embodiments. The STA receives an ICF from the AP, the ICF indicating a planned TXOP during which the AP is to transmit data packets to the STA via a first access technology, e.g. WiFi. In response to the received ICF, the STA transmits an ICR that provides unavailability information to the AP, including a time period during which the STA is unable to receive the data packets via the first communication access technology, due to a planned communication commitment via a second access technology. FIG. 6A indicates three cases that may apply, depending on the unavailability time period start and end times (e.g., Coex unavailability) of the STA.

Case 1 illustrates an unavailability duration A-B that occurs outside of the time frame of the TXOP planned by the AP. For case 1, the TXOP can be executed as planned without needing to reschedule the TXOP, or to reduce the time frame of the TXOP, (e.g., no need to reduce an amount of data to be sent to the STA 1).

Case 2 illustrates an unavailability duration A-B that includes a portion of the timeline planned by the AP for the TXOP.

Case 3 illustrates an unavailability duration A-B that lies completely within the planned TXOP timeline.

Considering cases 2 and 3, the unavailability duration A-B partially or entirely overlaps with a planned TXOP as indicated by the ICF emitted by the AP, and hence the STA is unavailable during a part of the planned TXOP.

FIG. 6B illustrates a UUA issued by the STA to indicate unavailability of the STA to receive Wifi transmission from the AP, e.g., Coex unavailability as a result of transmission via a different transmission medium (e.g., cellular transmission), which will utilize communication portions of the STA and hence be unavailable for WiFi communication with the AP. The UUA may be issued without a prior prompt, e.g., without reception by the STA of an ICF transmitted by an AP. Responsive to receipt of the UUA, the AP issues an acknowledgment (Ack) to the STA.

With regard to power management in FIGS. 6A and 6B, the STA may be Active mode or Power Save mode at the start of the Coex unavailability period (i.e., at the time point A). If at point A, the STA is in active mode, the STA is unavailable during the indicated Coex unavailability period (that is, time A to time B), and remains in the active mode till the end of the Coex unavailability period. If at point A, the STA is in power save mode, the STA is in doze state during the indicated Coex unavailability period (that is, time A to time B), and remains in the power save mode till the end of the Coex unavailability period.

With regard to FIG. 6B, in some other embodiments, the UUA frame may be a QoS Null frame or other frame type such as a management frame, where the Coex unavailability information (the start time, the duration, and a link bitmap indicating to which links the Coex unavailability applies) is included in an A-control field of the UUA frame. In some other embodiments, the UUA frame may be a control frame or a management frame. An acknowledgement frame to the UUA frame may be transmitted by the AP as a confirmation of the reception of the UUA frame.

If the Unavailability Duration partially or entirely overlaps with a TWT service period (SP), the STA overrides the TWT requirement and is unavailable to receive packets.

In FIGS. 6A, 6B, during the Coex unavailability duration announced either by an ICR or an UUA, the AP shall buffer the individually addressed BUs addressed to STA 1 if the AP is unable to deliver the BU(s) on another link of the MLD where the STA affiliated with the same non-AP MLD is available.

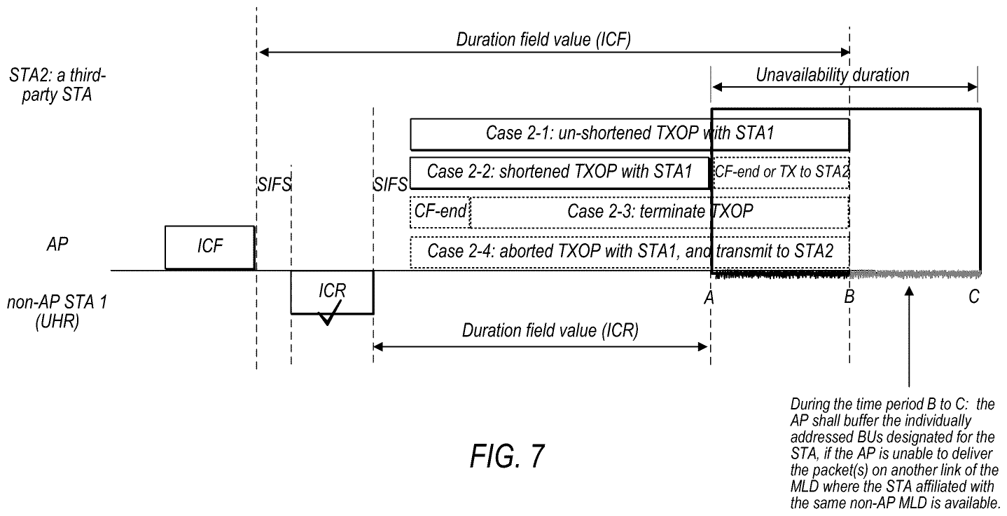

FIG. 7 illustrates 4 sub-cases (“Case 2-x”) of Case 2 of FIG. 6A, in which Coex unavailability starts within the TXOP and ends outside of the TXOP (as originally planned by the AP). The AP may behave according to any of four depicted cases.

In Case 2-1, the AP does not react to the Coex unavailability indication provided in the ICR sent by the STA (e.g., due to a short time in which to respond, and continues to send data during the entirety of the planned TXOP, although the STA is unavailable during A-B.

In case 2-2 (“smart AP”) the AP shortens the TXOP with the STA1 according to feedback from STA1 (e.g., via the ICR). During the unavailability of STA1, AP may send a CF-END Frame to terminate the remainder of the TXOP. Alternatively, AP sends the remainder of the data to be transmitted, to another (third-party) station (STA2).

Case 2-3: AP cannot successfully communicate the data intended to be transmitted, and sends CF-END frame, and AP cancels TXOP and does not transmit to any station. By canceling the TXOP, AP surrenders a transmission medium by which data is to be transmitted.

Case 2-4: AP aborts TXOP with STA1 and instead transmits the data to a third-party STA2.

In each of the 4 cases 2-1 through 2-4, during a portion B-C of the unavailability duration, the AP may buffer individually addressed bufferable units (BUs) designated for the STA, or the AP may deliver the BUs on another link of a multi-link device (MLD) with which the STA is affiliated, e.g. to another STA affiliated with the same non-AP MLD that is available.

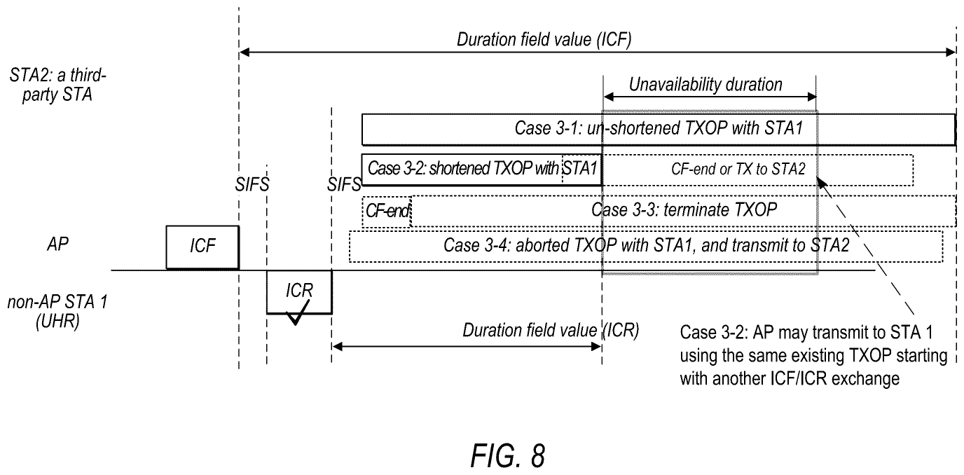

FIG. 8 depicts 4 sub cases (case 3-x) of Case 3 of FIG. 6A.

Case 3-1: the AP does not react to the Coex unavailability indication provided in the ICR sent by the STA e.g., due to a short time in which to respond, and continues to send data during the entirety of the planned TXOP, although the STA is unavailable during A-B.

Case 3-2, AP shortens TXOP with STA1, transmitting an abbreviated amount of data to STA1 within duration field value (communicated to the AP in the ICR) before the unavailability duration begins. During the Coex unavailability period, the AP may transmit a CF-END frame to terminate the remainder of the TXOP, or transmit to a third-party device. If, during the Coex unavailability period, the AP doesn't terminate the remainder of the TXOP, the AP can resume sending data to STA1 after the unavailability period ends by sending another ICF to STA1 and receiving in response another ICR from STA1.

Case 3-3: AP sends CF-END frame and cancels the TXOP.

Case 3-4: AP aborts TXOP with STA1 and instead transmits the data to a third-party device STA2.

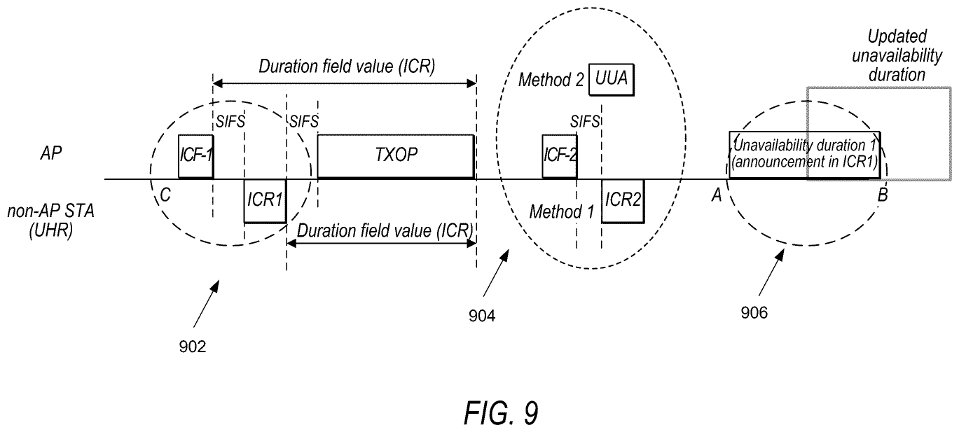

FIG. 9 is directed to update previously announced unavailability information. As depicted in 902, the AP sends ICF1 to the STA, and in response receives ICR1, which includes an indication of an unavailability duration of the STA.

As depicted in 904, according to method 1, before the beginning of the Coex unavailability information previously announced in ICR1, the AP sends ICF2 and receives ICR2 that indicates an updated unavailability information, which overrides the previously sent indication of unavailability information. Alternatively, according to method 2, the STA may initiate a UUA that indicates the updated unavailability information to the AP, which overrides a previously sent indication of unavailability information.

At 906, the updated availability duration (shifted to a later start time) is illustrated in comparison to the unavailability information previously indicated by ICR 1 to the AP.

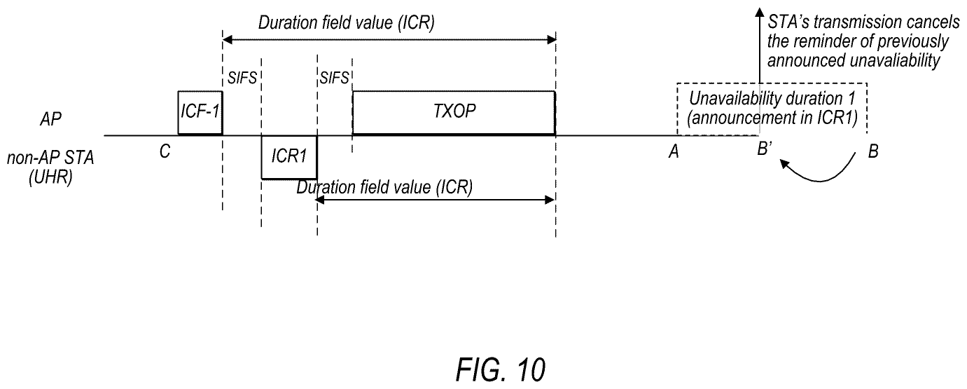

FIG. 10 addresses an update by the STA during the unavailability period that has been established by ICR 1 in response to an ICF 1, the STA may send a packet (e.g. a packet of any type, e.g., data packet) to the AP, which cancels the remainder of the unavailability period previously established. In one embodiment, the packet sent to the AP may contain new availability information of the STA, e.g., updated unavailability information, or no unavailability information.

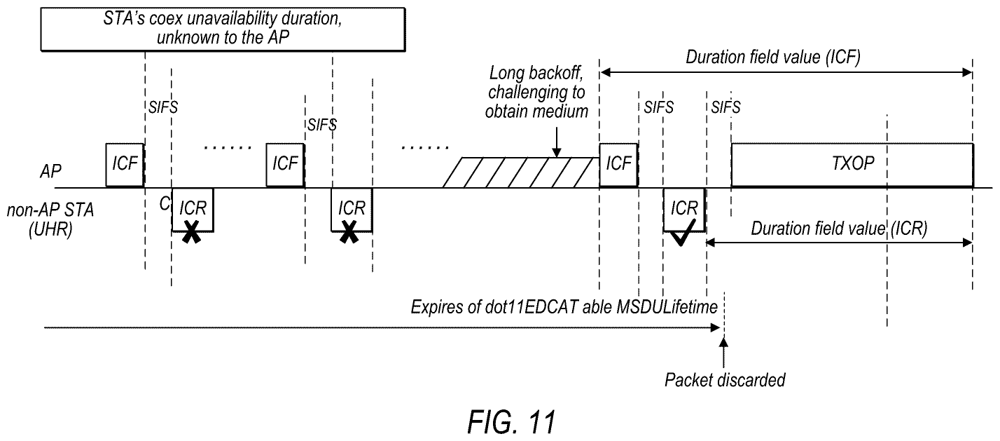

FIGS. 11-17 address failures and recovery methods for a system that includes an AP and a STA.

FIG. 11 illustrates, for a system employing block acknowledgment (BA) agreement, time between successive ICFs when no ICR is received (e.g., failure of acknowledgment of ICF received). Typically, a failure to receive an ICR results in an increase of Q station retry counter (QSRC) and an increase of a contention window CW, thus an increase in time to access the wireless medium to transmit a frame. With an expiration of dot 11QAPEDCAT Table MSDU Lifetime, a data packet is discarded. A long backoff in execution of a retry ICF results in potentially increasing difficulty to obtain use of a transmission medium by which to deliver data packets, and is wasteful with regard to medium usage.

In an embodiment, to mitigate or avoid such failures, an STA can transmit an unsolicited unavailability announcement (UUA) frame, so that the AP knows the STA's unavailability information and avoids transmitting an ICF to the STA during the STA's unavailability, and therefore avoids failure of ICF/ICF exchange. If an initial UUA to indicate upcoming Coex unavailability does not result in an acknowledgment, the STA can submit another UUA frame to the AP. That is, if the STA has previously sent a UUA transmission to the AP but the UUA was not successfully acknowledged, the STA can send another UUA frame to indicate upcoming Coex unavailability.

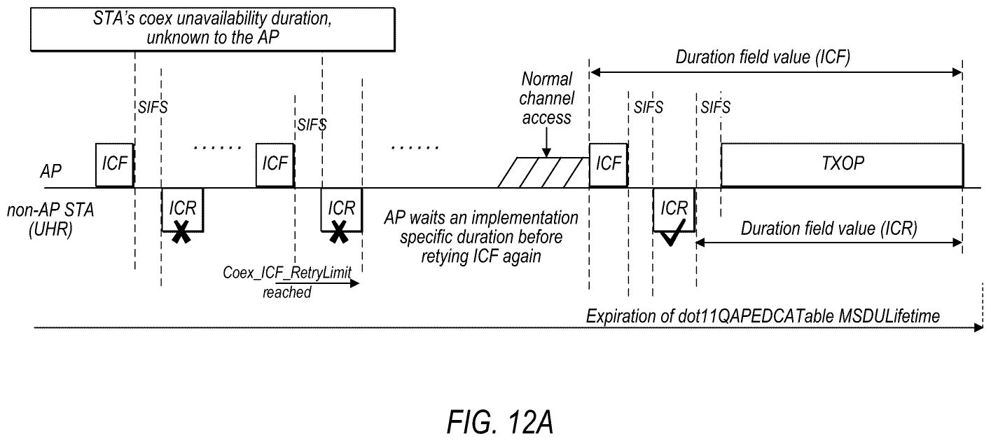

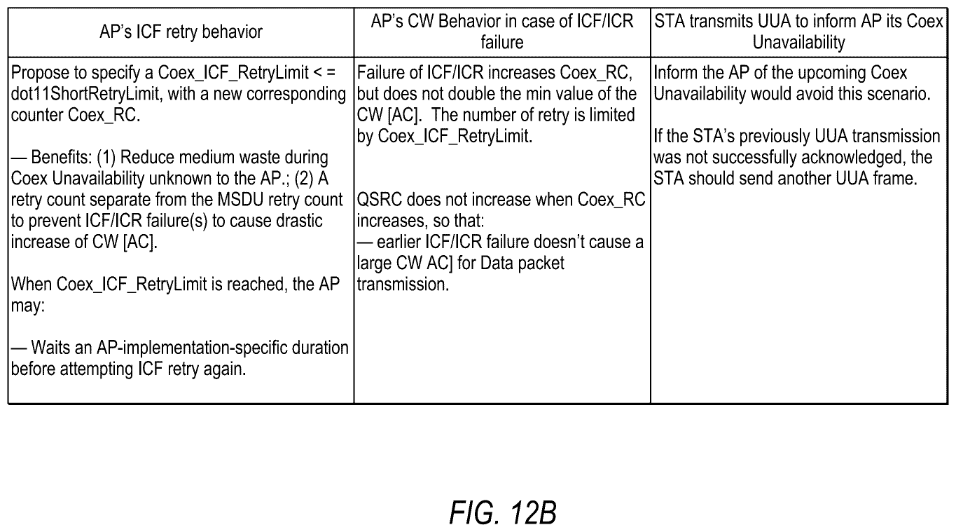

As illustrated in FIG. 12, in an embodiment, when an ICF is sent by the AP and does not result in an ICR sent in return to the AP, a new counter “Coex_RC” (with a corresponding retry limit “Coex_ICF_RetryLimit”) may be employed that does not increase a size of the contention window (CW) (e.g., does not result in an extended CW that may be as much as double the size of a CW, as depicted in FIG. 11). Thus, after a failure of ICF/ICR exchange, a subsequent Coex_ICF_RetryLimit is employed that does not increase a size of the contention window for data packet transmission. When the Coex_ICF_RetryLimit is reached, the AP may wait an AP-implementation-specific duration before attempting an ICF retry.

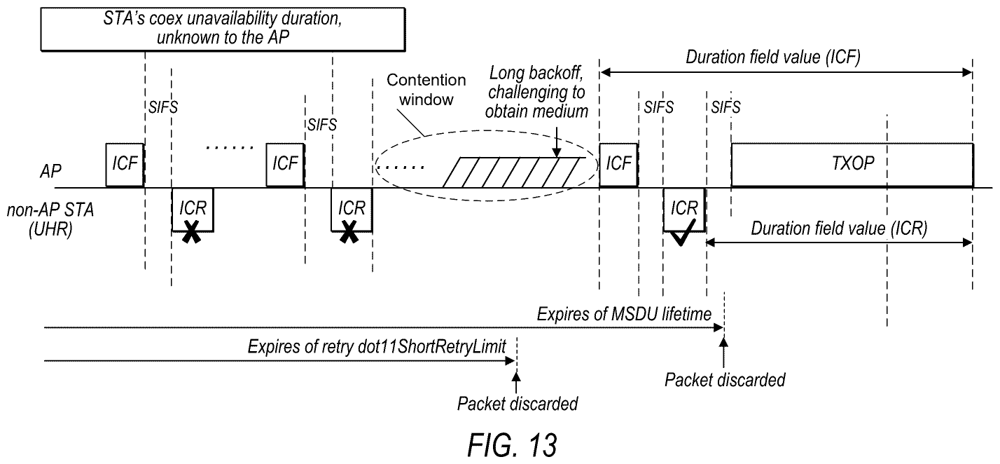

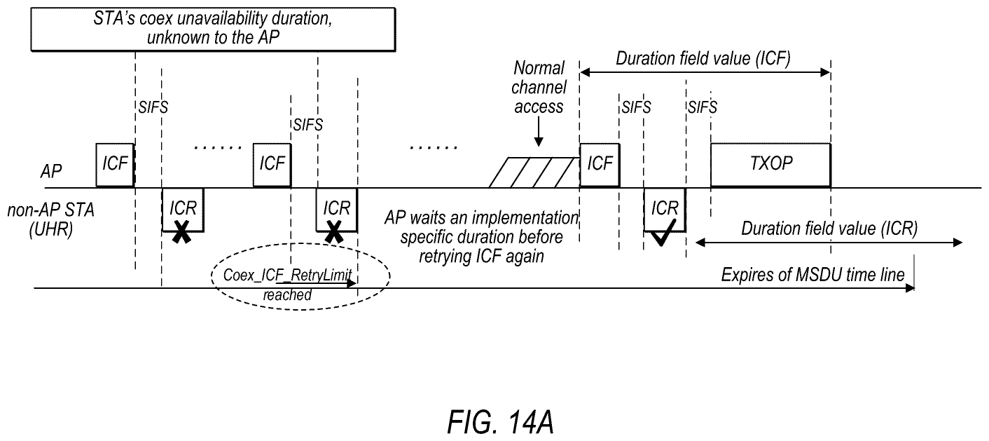

FIG. 13 depicts ICF/ICR failure without Block Acknowledgment (BA) agreement. As shown in FIG. 13, an ICF/ICR failure increases Q station retry counter QSRC, which doubles contention window (CW) and leads to a long backoff, which results in increased difficulty in obtaining the medium to deliver data packet(s). Additionally, in this system without BA agreement, discarding of a data packet occurs either at the expiration of retry dot 11 (Short Retry Limit), or the MSDU retry lifetime, whichever occurs first, as depicted in FIG. 11.

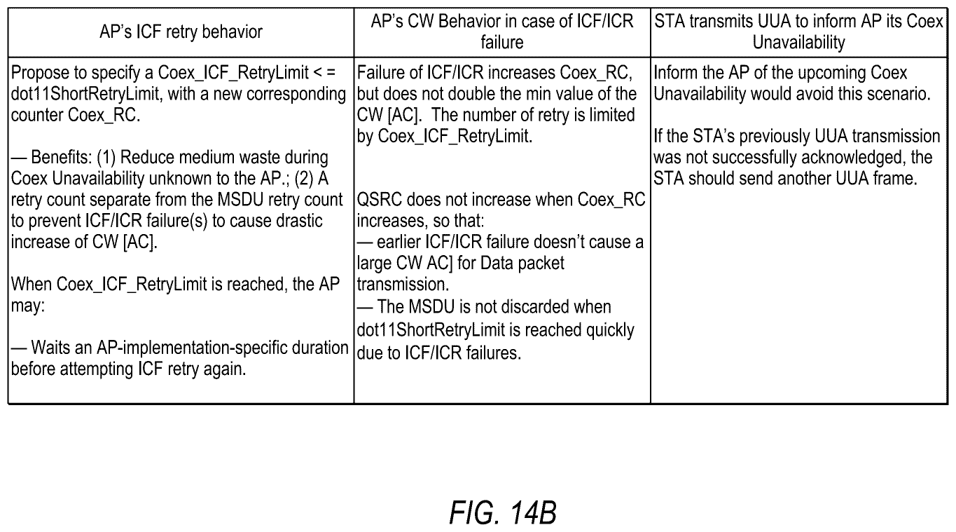

FIGS. 14A,B suggest remedies for the ICF/ICR failure include a new counter Coex RC with the corresponding retry limit Coex_ICF_retrylimit. Coex_RC is increased by one for every ICF/ICR exchange failure, e.g., the ICF/ICR exchange failure will cause the Coex RC to be increased by one; however, the contention window is not doubled. That is, the ICF/ICR exchange failure as depicted in FIG. 14A, does not increase the CW or cause difficult channel access for the subsequent data packet delivery. Instead, the subsequent data packet delivery is not penalized by the failure and retry failure of the ICF/ICR exchange.

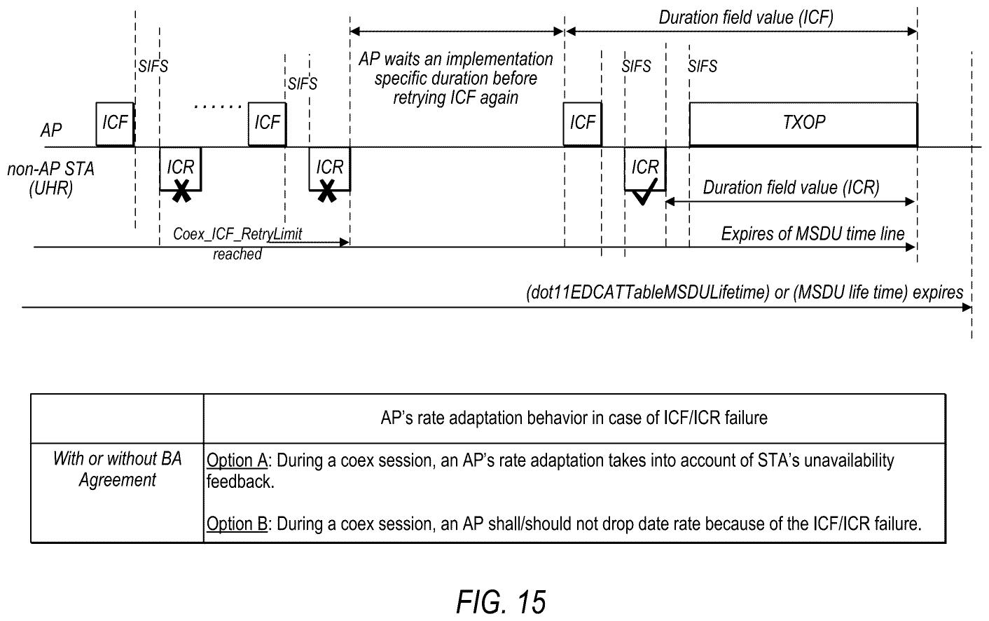

FIG. 15 summarizes AP data rate adaptation due to ICF/ICR failures, with or without BA agreement. In Option A, during a Coex session AP's rate adaption takes into account STA's unavailability feedback and does not simply assume bad link quality. In Option B, during a Coex session, the AP does not drop the data rate merely due to ICF/ICR failure.

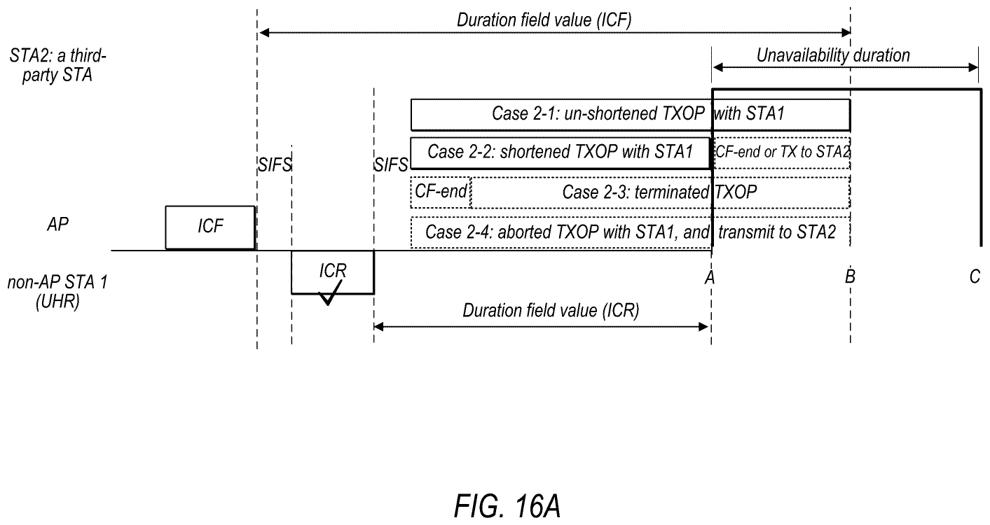

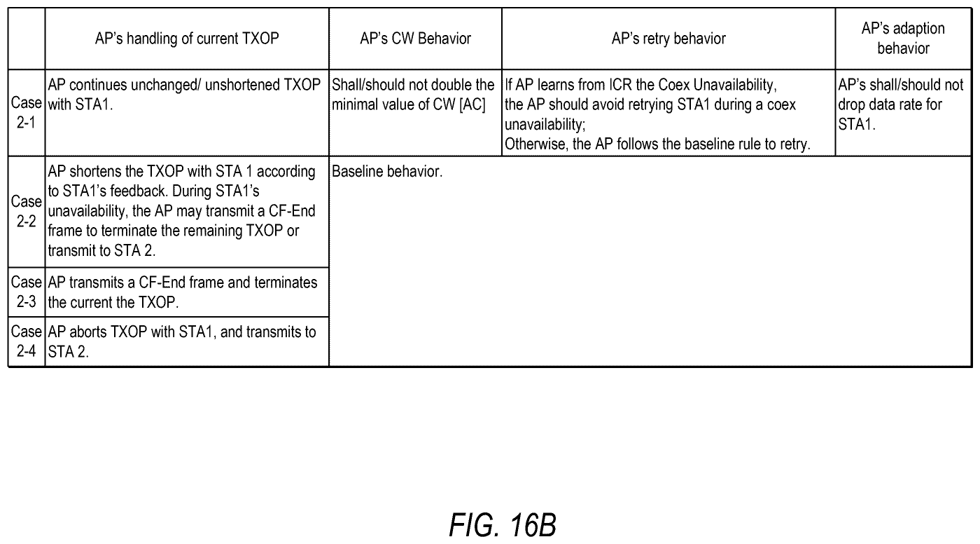

FIG. 16A,B summarizes data packet failure and recovery options, according to embodiments herein for cases 2-1, 2-2, 2-3, 2-4, as initially presented in FIG. 7, e.g., unavailability duration is partly within, and partly outside of the TXOP time span planned by the AP.

In case 2-1, AP continues unchanged/unshortened TXOP with STA1 and results in a packet failure. Regarding contention window (CW), AP does not double a minimum value of the CW. Regarding AP's retry behavior, if AP learns from the ICR that there is Coex unavailability, the AP avoids retrying STA1 during a Coex unavailability. Regarding data rate, the AP does not drop the data rate for STA1.

In case 2-2, AP shortens the TXOP with STA1 according to STA1 feedback. During Coex unavailability of STA1, the AP may transmit a CF-End frame to terminate the remaining TXOP; alternatively, the AP may transmit data during the remaining portion of TXOP to another station (STA2).

In case 2-3, AP transmits a CF-End frame and terminates the current TXOP.

In case 2-4, AP aborts TXOP with STA1, and instead transmits data to a third-party STA2.

For cases 2-2, 2-3 and 2-4, in some embodiments, methods that AP executes following a data failure may include conventional actions.

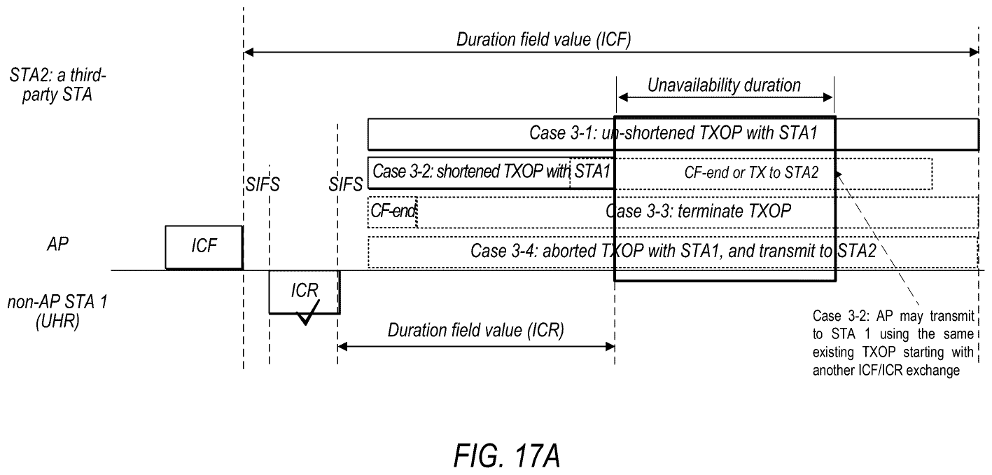

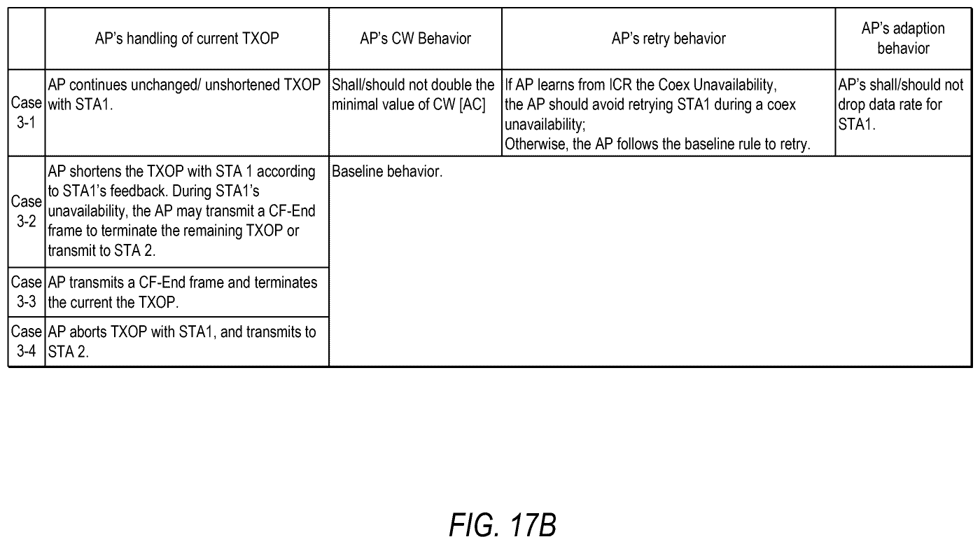

FIGS. 17A,B summarize data packet failure and recovery options, according to embodiments herein for cases 3-1, 3-2, 3-3, 3-4, as initially presented in FIG. 8, e.g., unavailability duration is entirely within the TXOP planned by the AP.

In case 3-1, AP continues unchanged/unshortened TXOP with STA1 and results in packet failure. Regarding contention window (CW), AP does not double a minimum value of the CW. Regarding AP's retry behavior, if AP learns from the ICR that there is Coex unavailability, the AP avoids retrying STA1 during a Coex unavailability. Regarding data rate, the AP is not to drop the data rate for STA1.

In case 3-2, AP shortens the TXOP with STA1 according to STA1 feedback. During Coex unavailability of STA1, the AP may transmit a CF-End frame to terminate the remaining TXOP; alternatively, the AP may transmit data during the remaining portion of TXOP to another station (STA2). After the Coex unavailability has finished, if AP wants to return to STA1, AP may send another ICF and receive an ICR in response that indicates STA1 is available to receive additional data.

In case 3-3, AP transmits a CF-End frame and terminates the current TXOP.

In case 3-4, AP aborts TXOP with STA1, and instead transmits data to STA2.

For cases 3-2, 3-3 and 3-4, in some embodiments, methods that AP executes following a data failure may include conventional actions.

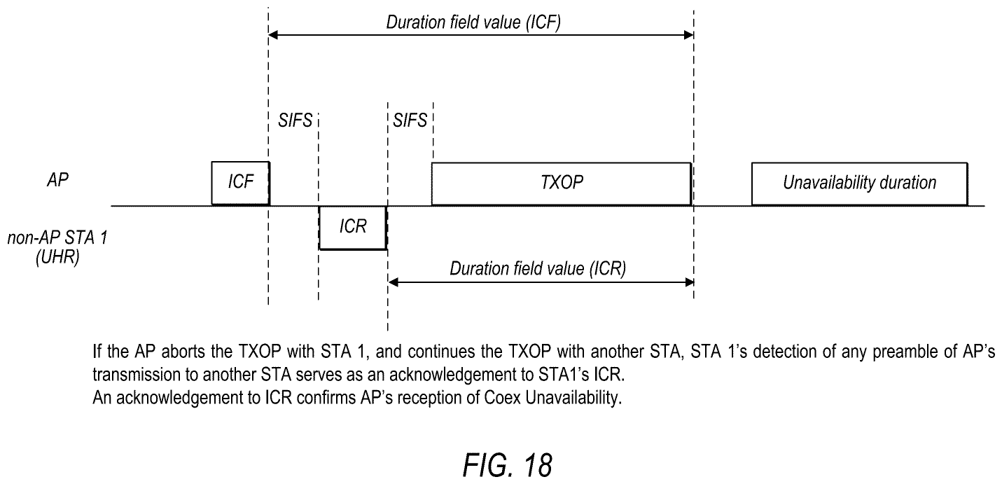

FIG. 18 illustrates acknowledgement to the ICR that has been sent to the AP responsive to ICF received by STA, where the unavailability period starts after the AP's planned TXOP. If the AP continues TXOP with STA 1 after ICR is received, any download (DL) transmission during the TXOP serves as an acknowledgment to ICR. An acknowledgment of ICR confirms reception by AP of Coex unavailability of STA1.

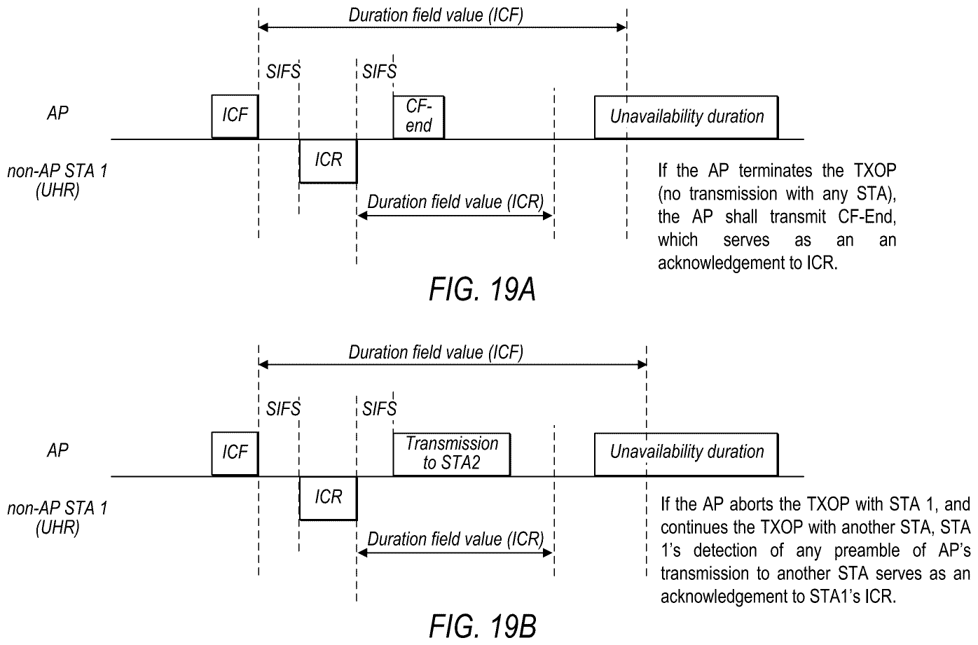

FIGS. 19A, B address acknowledgement to an ICR where unavailability duration occurs within a duration field value of ICF. Illustrated in FIG. 19A, after receiving ICR responsive to the ICF, AP may choose to terminate the TXOP e.g., no transmission with any STA. In this case, the AP transmits a CF-End, which serves as an acknowledgment to ICR. Illustrated in FIG. 19B, after receiving the ICR, AP aborts the TXOP with STA1 and continues the TXOP with another station: STA2. Detection by STA1 of any preamble of transmission by AP to STA2 may serve as an acknowledgment of receipt by the AP of the ICR of STA1.

For all scenarios in FIGS. 18, 19A and 19B, if ICR containing the Coex unavailability is acknowledged by the AP using the respective method described, then STA does not transmit the same unavailability information again, e.g., does not repeat transmission of the unavailability information.

During the PBT (ICF/ICR) setup process, a STA and an AP may each indicate a respective Coex behavior policy. For example, a Coex behavior policy that the STA may indicate during the setup is: if TXOP cannot be shortened, the AP aborts the transmission. Another Coex behavior policy that may be indicated by the STA is: a desired number of ICF retries in case of ICF/ICR failure. Yet another Coex behavior policy that may be indicated by the STA is: a desired number of ICR retries in case of ICF/ICR failure. Yet another Coex behavior policy that may be indicated by the STA is: whether the STA is willing to participate in a multiple user (MU) Coex group. Alternatively, other policies may be indicated by the STA during setup.

AP may indicate various policies during setup. For example, a policy of the AP may include: the AP can shorten a TXOP short interframe space (SIFS) (see FIGS. 19A, 19B) after receiving an ICR. As another example, the AP may indicate a different policy: if a TXOP cannot be shortened, AP is to abort the TXOP. Another policy that may be indicated by the AP during setup is: if a TXOP cannot be shortened, the AP is to continue with the TXOP. Yet another policy that may be indicated by the AP during setup is AP's contention window (CW) behavior in case of packet failure, e.g., to lengthen (or not lengthen) the contention window in case of packet failure. Yet another policy that may be indicated by the AP during setup is a number of ICF retries in the event of ICF/ICR failures. Yet another policy that may be indicated by the AP during setup is a number of ICF retries in case of data packet failures. Alternatively, other policies may be indicated by AP during setup.

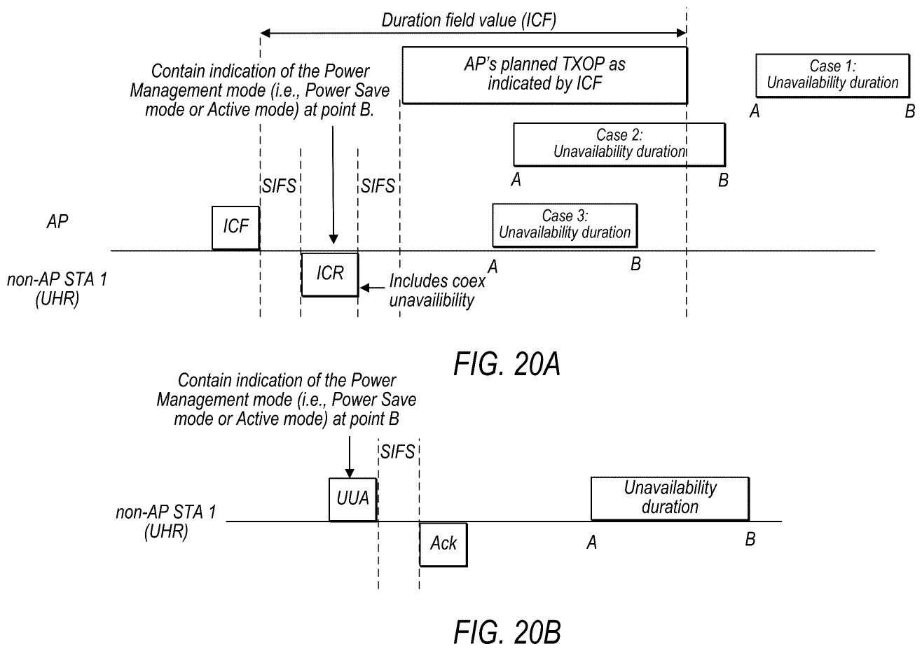

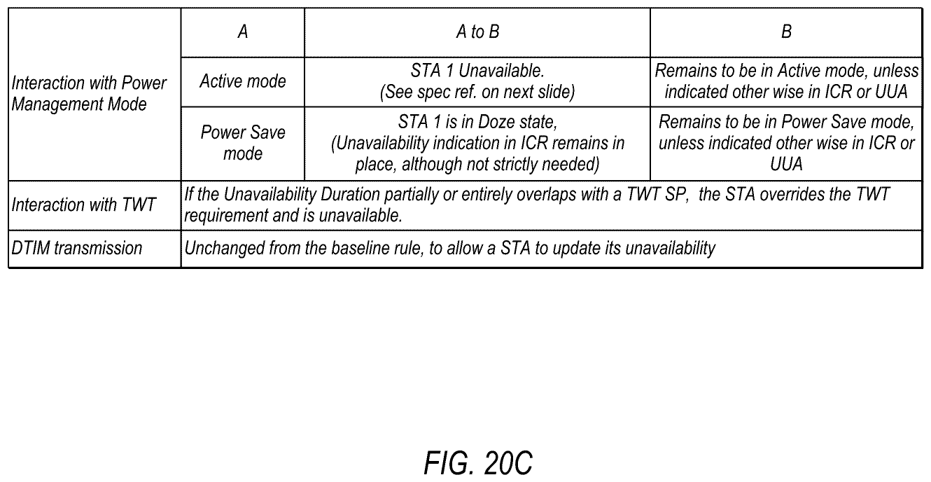

FIGS. 20A,B,C illustrate embodiments in which STA has ability to indicate power management mode (Active mode or Power Save mode) at the end of the unavailability period. The STA may indicate, via ICR (FIG. 20A) or via UUA (FIG. 20B), Coex unavailability. The ICR (or UUA) may also indicate power management mode (Active or Power Save) at the end (point B) of the unavailability duration A-B. For example, in an embodiment STA is in active mode at point A. Between A and B, STA is unavailable. At B, STA remains in active mode; however, the STA is in Power Save mode at time point B if the STA indicates so in the ICR or an UUA that contains the unavailability information.

In another embodiment, STA is in power save mode at the beginning of unavailability period. Between A and B STA is in power save mode (“doze state”). At B STA remains in power save mode, however, the STA is in Active mode at time point B if the STA indicates so in the ICR or an UUA that contains the unavailability information.

Regarding Delivery Traffic Indication Message (DTIM) transmission that warns clients that the AP is about to transmit frames, in embodiments the transmission follows conventions in 802.11 standard.

In an embodiment, a UUA frame may be transmitted only when the reported unavailability period is longer than a threshold value. Such a threshold value may be an implementation-specific internal value, or may be communicated by the STA to the AP, or may be specified in a new 802.11 standard amendment.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a first wireless device:
receiving, from a second wireless device, information indicating an unavailability period during which the second wireless device is unable to receive data packets sent from the first wireless device; and
determining, based on the received information, an execution plan to transmit the data packets to the second wireless device.

2. The method of claim 1, wherein the execution plan includes determining, based on the received information, to adjust a duration of a transmission opportunity time period (TXOP) during which the data packets are sent, from a planned TXOP duration to an adjusted TXOP duration, wherein for the adjusted TXOP duration, the second wireless device is available to receive the data packets.

3. The method of claim 1, further comprising:
sending to the second wireless device an initial control frame (ICF) that indicates a planned transmission opportunity time period (TXOP) for sending data packets to the second wireless device; and
receiving an initial control response (ICR) from the second wireless device in response to receipt by the second wireless device of the ICF, wherein the ICR indicates the unavailability period.

4. The method of claim 3, further comprising after receiving the ICR, sending:
an acknowledgement of receipt of the ICR to the second wireless device;
a CF-END frame to the second wireless device; or
a transmission to another wireless device.

5. The method of claim 1, further comprising:
sending to the second wireless device an initial control frame (ICF) that indicates a planned transmission opportunity time period (TXOP) planned for sending data packets to the second wireless device; and
receiving an initial control response (ICR) from the second wireless device in response to receipt by the second wireless device of the ICF, wherein the ICR updates the information indicating the unavailability period.

6. The method of claim 1, wherein the unavailability period overlaps at least in part with a transmission opportunity time period (TXOP) planned for the first wireless device to transmit data packets to the second wireless device, and the execution plan includes determining, based on the received information, to:
terminate the TXOP, wherein termination cancels transmission of the data packets during the TXOP; or
transmit, during the TXOP, at least some of the data packets to another wireless device.

7. The method of claim 1, wherein the information received is included in an unsolicited unavailability announcement (UUA) from the second wireless device, wherein the information updates a previously announced unavailability period.

8. The method of claim 1, wherein the information is received in an unsolicited unavailability announcement (UUA) from the second wireless device, wherein the unavailability information includes unavailability start time, unavailability duration, and a link bitmap indicating to which links the unavailability applies, wherein the information is included in an A-control field of the UUA.

9. The method of claim 1, wherein the information received is included in an unsolicited unavailability announcement (UUA) from the second wireless device, wherein the information indicates a power management mode at an endpoint of the unavailability period.

10. The method of claim 1, wherein the unavailability period overlaps at least in part with a transmission opportunity time period (TXOP) planned for the first wireless device to transmit data packets to the second wireless device, and wherein the execution plan comprises shortening the TXOP responsive to the information received.

11. The method of claim 1, wherein the execution plan includes:
during the unavailability period, transmitting at least some of the data packets to a third wireless device instead of the to the second wireless device.

12. The method of claim 1, further comprising:
receiving an initial control response (ICR) from the second wireless device in response to receipt by the second wireless device of the ICF, wherein the ICR indicates a power management mode at an endpoint of the unavailability period.

13. A processor comprising memory configured to cause the processor to perform operations comprising:
receiving, from a second wireless device, information indicating an unavailability duration during which the second wireless device is unable to receive data packets sent from a first wireless device responsive to commands issued by the processor; and
determining based on the received information, an execution plan for execution by the first wireless device to transmit the data packets from the first wireless device to the second wireless device.

14. The processor of claim 13, wherein the execution plan comprises determining, based on the received information, to adjust a duration of a transmission opportunity time period (TXOP) during which the data packets are sent, from a planned TXOP duration to an adjusted TXOP duration, wherein for the adjusted TXOP duration, the second wireless device is available to receive the data packets.

15. The processor of claim 13, wherein the processor is further configured to perform additional operations comprising:
sending to the second wireless device an initial control frame (ICF) that indicates a transmission opportunity time period (TXOP) for sending data packets to the second wireless device; and
receiving an initial control response (ICR) from the second wireless device in response to receipt by the second wireless device of the ICF, wherein the ICR indicates the unavailability period.

16. The processor of claim 15, wherein the processor is further configured to perform additional operations comprising after receiving the ICR, sending:
an acknowledgement of receipt of the ICR to the second wireless device;
a CF-END frame to the second wireless device; or
a transmission to another wireless device.

17. The processor of claim 13, wherein the processor is further configured to perform additional operations comprising:
sending to the second wireless device an initial control frame (ICF) that indicates a planned transmission opportunity time period (TXOP) duration for sending data packets to the second wireless device; and
receiving an initial control response (ICR) from the second wireless device in response to receipt by the second wireless device of the ICF, wherein the ICR updates the information indicating the unavailability period.

18. A wireless device, comprising:
one or more antennas;
one or more radios operably coupled to the one or more antennas; and
a processor operably coupled to the one or more radios;
wherein the wireless device is configured to:
receive, from a second wireless device, information indicating an unavailability period during which the wireless device is unable to receive data packets sent to the second wireless device from the wireless device; and
determine based on the received information, an execution plan to transmit the data packets to the second wireless device.

19. The wireless device of claim 18, wherein the execution plan comprises determining, based on the received information, to adjust a duration of a transmission opportunity time period (TXOP) during which the data packets are sent, from a planned TXOP duration to an adjusted TXOP duration, wherein for the adjusted TXOP duration, the second wireless device is available to receive the data packets.

20. The wireless device of claim 18, the wireless device further configured to:
send to the second wireless device an initial control frame (ICF) that indicates a transmission opportunity time period (TXOP) for sending data packets to the second wireless device; and
receive an initial control response (ICR) from the second wireless device in response to receipt by the second wireless device of the ICF, wherein the ICR updates the unavailability period.
